(19) United States
(12) Patent Application Publication
(10) Pub. No.: US 2004/0135817 A1
(43) Pub. Date: Jul. 15, 2004

(54) Interface for selecting and performing operations on objects

(76) Inventors: Joey L. Daughtery, Buford, GA (US); Craig Pickering, Alpharetta, GA (US); Gregory D. Pickering, Atlanta, GA (US)

Correspondence Address: Gregory Scott Smith, P.O. Box 88148, Atlanta, GA, 30356, US

(21) Appl. No.: 10/341,657

(22) Filed: Jan. 14, 2003

(51) Int. Cl. G09G 5/00

(52) U.S. Cl. 345/823; 345/744

(57) ABSTRACT

A method for controlling the selection of objects is described, illustrated and claimed. The novel system and method allows for quick and efficient selection of all or a portion of a plurality of objects, while preserving the ability to select or deselect individual objects. An action is associated with a rule for selection of objects in a specific manner. When that action is performed, every object defined by the rule is either selected or deselected. The method allows for selection or deselection of multiple groups in the same manner, and also allows for selection of individual objects.

### TECHNICAL FIELD

The present invention relates to control interfaces for computer programs and, more particularly to a method of selecting and/or deselecting, or otherwise invoking an operation on multiple objects displayed by a computer program, in response to simple actions performed by a user or process.

### BACKGROUND OF THE INVENTION

Computer users have become accustomed to using computer software applications that present information through a graphical user interface. A number of methods for presenting information have become de facto standards. For instance, radio buttons, checkboxes, slide bars, and pushbuttons are used throughout the industry. These items are referred to as graphical user interface objects, or graphical objects. Users typically interact with software applications having a graphical user interface by moving a pointing cursor over a graphical object using, for example, a mouse or similar pointing device such as a light pen, and then indicating (for example, by clicking a mouse button or pressing the light pen) that the object should be selected. Alternatively, some graphical user interfaces may be presented on a touch-sensitive display screen. In that situation, the user interacts with the software application by touching the graphical object he wishes to select.

The programmer writing a software application having a graphical user interface defines the physical layout of the graphical objects on the user interface screen, as well as the function, if any, to be associated with the objects and any logical relationships among those objects. The function represented by a graphical object can be as simple as setting the value of a variable used by a software application, or it can represent a more complex function such as initiating the execution of a software subroutine, or any other function desired by the programmer.

When radio buttons and checkboxes are displayed on the screen, they are normally accompanied by text, which explains the function or purpose of the individual object. Each of these objects has a status associated with it, which is either “selected” or “not selected”. The face of the radio button or checkbox represents graphically to the user what the current status for that object's function is. When the user selects the radio button, such action is typically shown by displaying a black area that is smaller than the radio button, and located inside the larger button. When the radio button is deselected, it is shown as just the object without the black area inside. A checkbox is represented by a graphical object that resembles an empty box. When the checkbox is selected by the user, a check mark (or perhaps an “x”) is shown in the box, as if a person had written a check mark into a box with a pencil. When the checkbox is deselected, the check mark does not appear, so that the checkbox appears empty. While selection and deselection have been described here as a status set in response to a user interaction, it will be obvious to one skilled in the art that the default selection status of each object, as defined by the software application, will be represented in the same graphical manner.

By convention, rules are associated with the selection of radio buttons and checkboxes. Radio buttons have the characteristic of mutual exclusion. That is, of all the radio buttons in a logically-defined group, only one can be selected at a time: if one radio button is already selected when the user selects a different radio button from the group, the originally-selected button is automatically deselected. Checkboxes on the other hand, are not mutually exclusive. They function as multiple-choice selectors within a logically-defined group, so that any number of the checkboxes in the group can be selected at one time.

A limited amount of space is available on the display screen for presenting graphical objects and any corresponding text that may be required in order to explain the function of each object. The more choices that are available in a particular software application, the greater will be the number of graphical objects needed to represent those choices.

Programmers tend to physically group graphical objects that have some relationship, and often will define logical groups of objects as well. For example, radio buttons are defined as forming a logical group, in order to implement the mutual exclusion property for the group. The checkboxes belonging to a group will normally be located together on the display, according to their logical grouping. These logical groups of objects may be further divided into subgroups, which are groups within groups. The concepts of the present invention apply equally to logically-defined groups and to their logically-defined subgroups. Thus, the term “group” should be construed as including subgroups hereinafter unless otherwise indicated.

Existing software applications may present a type of group-controlling mechanism through use of a separate button or object designated, for example, “select all”. However, this type of object, with its corresponding textual explanation, occupies extra screen space on the display, and does not allow for selection of a portion of objects within the group. Further, a “select all” function is typically associated with a different type of user interface control, where a single pushbutton is provided to select all items in a multi-entry list, and where the function and the corresponding pushbutton are not associated with any logical subgroup of those items. In addition, existing software applications may present a type of group-controlling mechanism that selects all of the members of a logically-defined group of graphical user interface objects through the use of a spatially related graphical control object, for example a slide bar. This type of object also occupies extra screen space on the display, and does not allow for a selection of a portion of objects in a group.

An improvement in the ease and operation of a graphical interfaced can be realized by providing a mechanism for quickly and efficiently selecting (or deselecting) a portion of the graphical objects of a group with a single or limited operation, while preserving the ability to select (or deselect) all or individual items within the group. Each object must be accessed, one at a time or all at a time, to change the selection status. This can be very time-consuming, as well as tedious, for a user of the software application. It would be much more convenient for the user to be able to indicate, for example with a single or double click of a mouse button that he would like to select or deselect a portion of group of objects.

What is needed, therefore, is a solution that does not require extra text to explain the functioning of the control object or require another object to visibly indicate which objects it controls by the relative positioning of the control object, but which allows selection (or deselection) of a portion or all of a logical group of graphical objects with a single or simple operation. In addition, the user should be able to select or deselect individual graphical objects as well, to allow maximum flexibility in object selection.

### SUMMARY OF THE INVENTION

In general, the present invention can be described as a novel system and method for quickly and efficiently selecting or deselecting, or otherwise invoking an operation upon or related to, all or a portion of a plurality of objects, while preserving the ability to select or deselect, invoke an operation upon or related to, individual objects. More specifically, performing an action (i.e. single or double clicking on an object using a mouse, selecting and dragging the mouse, or pressing the object on a touch-sensitive screen, etc.) associated with a rule, invokes an operation on all or a portion of the plurality of objects dictated by the rule. The operation can include any of a variety of operations, such as, selecting or deselecting the objects, toggling or changing the state or status of an object, updating or refreshing the object, deleting or copying the object, changing the attributes of the object, or the like. Using the selecting and deselecting example, if the status of the plurality of objects was “not selected” before the user performs the action, the status of each object associated with the action and dictated by the rule will change to “selected” once the operation is performed on the object. The face of the object for each of the plurality of objects may then be modified to reflect the performance of such operation, for instance the face may then be shown with a mark in the object, to indicate this status. At that point, if the user wishes, he can deselect the entire plurality of objects or a portion of the objects by performing an action on the object in the same manner as before, or he can deselect individual objects by clicking on them individually.

An object of the present invention is to provide a technique for quickly and efficiently performing operations on all or a portion of a plurality of objects, while preserving the ability to perform operations on individual objects within the plurality of objects.

Another object of the present invention is to provide a technique for quick and efficient selection or deselection of all or a portion of a plurality of objects, while preserving the ability to select or deselect individual objects within the plurality of objects.

Another object of the present invention is to provide a technique for quick and efficient selection or deselection of a portion or multiple of portions of the plurality of objects, while preserving the ability to select or deselect individual objects within the plurality of objects.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a system diagram that illustrates an exemplary environment suitable for implementing various embodiments of the present invention.

FIG. 2 is an exemplary application utilizing an embodiment of the present invention.

FIG. 3A is a flow diagram illustrating the method of an exemplary embodiment of the present invention as perceived by a computing device.

FIG. 3B is the flow diagram of FIG. 3A with a loop-back feature further illustrating a method of an exemplary embodiment of the present invention as perceived by a computing device.

FIGS. 4A-F illustrate various aspects in which the objects used by the present invention may be depicted on a graphical user interface display of a computer workstation.

### DETAILED DESCRIPTION

In general, the present invention can be described as a novel system and method for quickly and efficiently performing operations on all or a portion of a plurality of objects, while preserving the ability to perform operations on individual objects. Some examples of objects include, but are not limited to: physically and logically grouped objects, ungrouped objects, graphical objects, graphical user interface objects, textual objects, etc. As with the exemplary embodiments below, these examples are for illustrative purposes only and, a person skilled in the art will construe them broadly.

Referring now to the figures, in which like numerals refer to like elements throughout the several views, exemplary embodiments of the present invention are described. Throughout the detailed description, reference will be made to the operation of the present invention when embodied within a computing device. Computing devices may include, but are not limited to, personal computers, mainframe computers, servers, and any other device capable of executing the software associated with the present invention. It should be understood that the features and aspects of the present invention can be ported into a variety of systems and system/network configurations and any examples provided within this description are for illustrative purposes only.

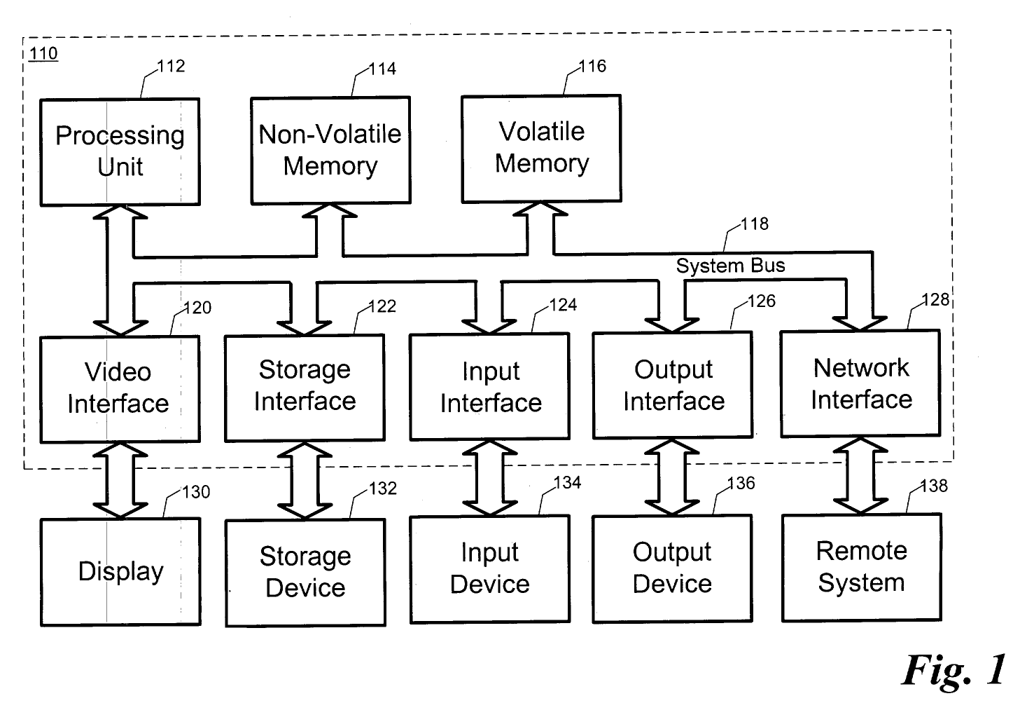

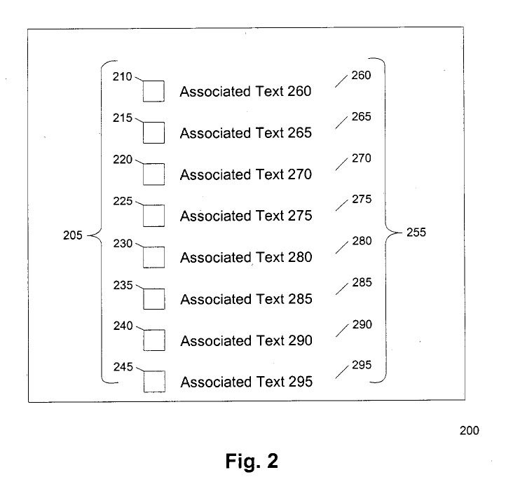

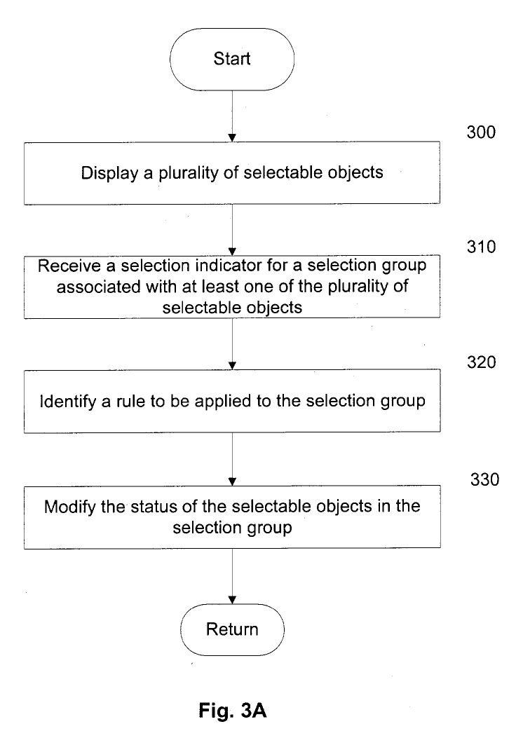

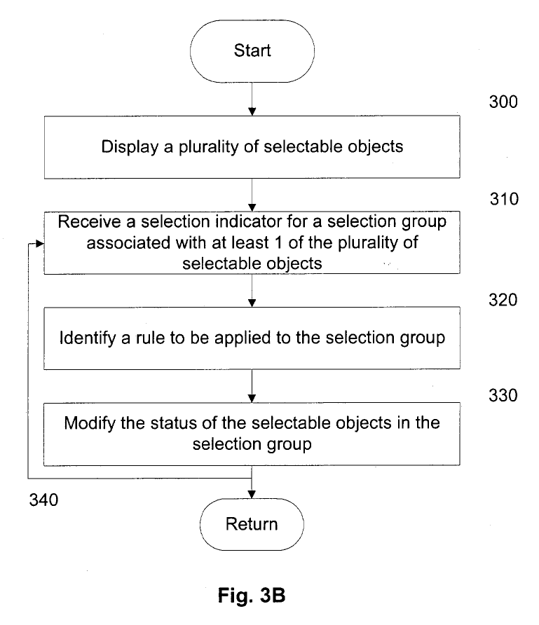

In conjunction with FIG. 1, the components of a general platform on to which aspects of the present invention can be implemented are described. Next, the components of a general application on to which aspects of the present invention are described in conjunction with FIG. 2. Finally, various operations of exemplary embodiments of the present invention are described in conjunction with FIGS. 3A-B and 4A-F.

### Exemplary Environment

FIG. 1 is a system diagram that illustrates an exemplary environment suitable for implementing various embodiments of the present invention. FIG. 1 and the following discussion provides a general overview of a platform onto which the invention, or portions thereof, may be integrated, implemented and/or executed. Although in the context of the exemplary environment the invention will be described as consisting of instructions within a software program being executed by a processing unit, those skilled in the art will understand that portions of the invention, or the entire invention itself may also be implemented by using hardware components, state machines, or a combination of any of these techniques. In addition, a software program implementing an embodiment of the invention may run as a stand-alone program or as a software module, routine, or function call, operating in conjunction with an operating system, another program, system call, interrupt routine, library routine, or the like. The term program module will be used to refer to software programs, routines, functions, macros, data, data structures, or any set of machine readable instructions or object code, or software instructions that can be compiled into such, and executed by a processing unit.

Those skilled in the art will appreciate that the system illustrated in FIG. 1 may take on many forms and may be directed towards performing a variety of functions. Generally, the system illustrated in FIG. 1 may be any system that includes a computer processor. Examples of such forms and functions include, but are not limited to, personal computers, hand-held devices such a personal data assistants, note-book computers, lap-top computers, mainframe computers, servers and a variety of other applications, each of which may serve as an exemplary environment for embodiments of the present invention.

The exemplary system illustrated in FIG. 1 includes a computing device 110 that is made up of various components including, but not limited to a processing unit 112, non-volatile memory 114, volatile memory 116, and a system bus 118 that couples the non-volatile memory 114 and volatile memory 116 to the processing unit 112. The non-volatile memory 114 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 114 provides storage for power on and reset routines (bootstrap routines) that are invoked upon applying power or resetting the computing device 110. In some configurations the non-volatile memory 114 provides the basic input/output system (BIOS) routines that are utilized to perform the transfer of information between elements within the various components of the computing device 110.

The volatile memory 116 may include, but is not limited to, a variety of memory types and devices including, but not limited to, random access memory (RAM), dynamic random access memory (DRAM), FLASH memory, EEPROM, bubble memory, registers, or the like. The volatile memory 116 provides temporary storage for routines, modules, functions, macros, data, etc. that are being or may be executed by, or are being accessed or modified by the processing unit 112. In general, the distinction between non-volatile memory 114 and volatile memory 116 is that when power is removed from the computing device 110 and then reapplied, the contents of the non-volatile memory 114 remain in tact, whereas the contents of the volatile memory 116 are lost, corrupted, or erased.

The computing device 110 may access one or more external display devices 130 such as a CRT monitor, LCD panel, LED panel, electro-luminescent panel, or other display device, for the purpose of providing information or computing results to a user. In some embodiments, the external display device 130 may actually be incorporated into the product itself. The processing unit 112 interfaces to each display device 130 through a video interface 120 coupled to the processing unit 110 over the system bus 118.

The computing device 110 may interface with one or more storage devices such as a hard disk drive, a compact disk drive, a floppy disk drive, a RAM drive or other memory drive, for the purpose of storing information, program data or programs. The storage device 132 is accessed through a storage interface 122 that connects to the system bus 118.

The computing device 110 may send output information, in addition to the display 130, to one or more output devices 136 such as a speaker, modem, printer, plotter, facsimile machine, RF or infrared transmitter, computer or any other of a variety of devices that can be controlled by the computing device 110. The processing unit 112 interfaces to each output device 136 through an output interface 126 coupled to the processing unit 112 over the system bus 118. The output interface 126 may include one or more of a variety of interfaces, including but not limited to, cable modems, DLS, T1, V series modems, an RS-232 serial port interface or other serial port interface, a parallel port interface, a universal serial bus (USB), a general purpose interface bus (GPIB), an optical interface such as infrared or IRDA, an RF or wireless interface such as Bluetooth, or other interface.

The computing device 110 may receive input or commands from one or more input devices 134 such as a keyboard, pointing device, mouse, modem, RF or infrared receiver, microphone, joystick, track ball, light pen, game pad, scanner, camera, computer or the like. The processing unit 112 interfaces to each input device 134 through an input interface 124 coupled to the processing unit 112 over the system bus 118. The input interface 124 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

It will be appreciated that program modules implementing various embodiments of the present invention may be stored in the non-volatile memory 114, the volatile memory 116, or in a remote memory storage device accessible through the output interface 126 and the input interface 124. The program modules may include an operating system, application programs, other program modules and program data. The processing unit 112 may access various portions of the program modules in response to the various instructions contained therein, as well as under the direction of events occurring or being received over the input interface 124.

The computing device 110 may interface with one or more remote systems 138, such as a server or client, through a network interface 128. In a networked configuration, some or all of the components of the present invention may be distributed and operate on one or more remote systems 138. The present invention may be embodied in a web application that is assessable on a remote system 138 through a browser type application running on processing unit 112.

### Components of a Typical Screen

FIG. 2 is a “screen shot” 200 that illustrates an exemplary embodiment of the present invention. Generally, the screen shot illustrated in FIG. 2 may be any screen that includes selectable objects. Examples of such forms and functions that a screen may be displayed on include, but are not limited to, personal computers, hand-held devices such a personal data assistants, note-book computers, lap-top computers, mainframe computers, servers and a variety of other applications, each of which may serve as an exemplary environment for embodiments of the present invention.

More particularly, the screen shot 200 in FIG. 2 includes a plurality of selectable objects 205 with associated text 255. The selectable objects 205 are check boxes with a status of “not selected.” Each of the plurality of selectable objects 205 are depicted individually and defined by numerals 210 to 245. The associated text 255 can be any type of text or even a graphical element and is depicted individually and defined by numerals 260 to 295. Checkbox 210 is associated with text 260, therefore when checkbox 210 is “selected” its associated text 260 is, in essence, selected as well.

### Operations of Exemplary Embodiments

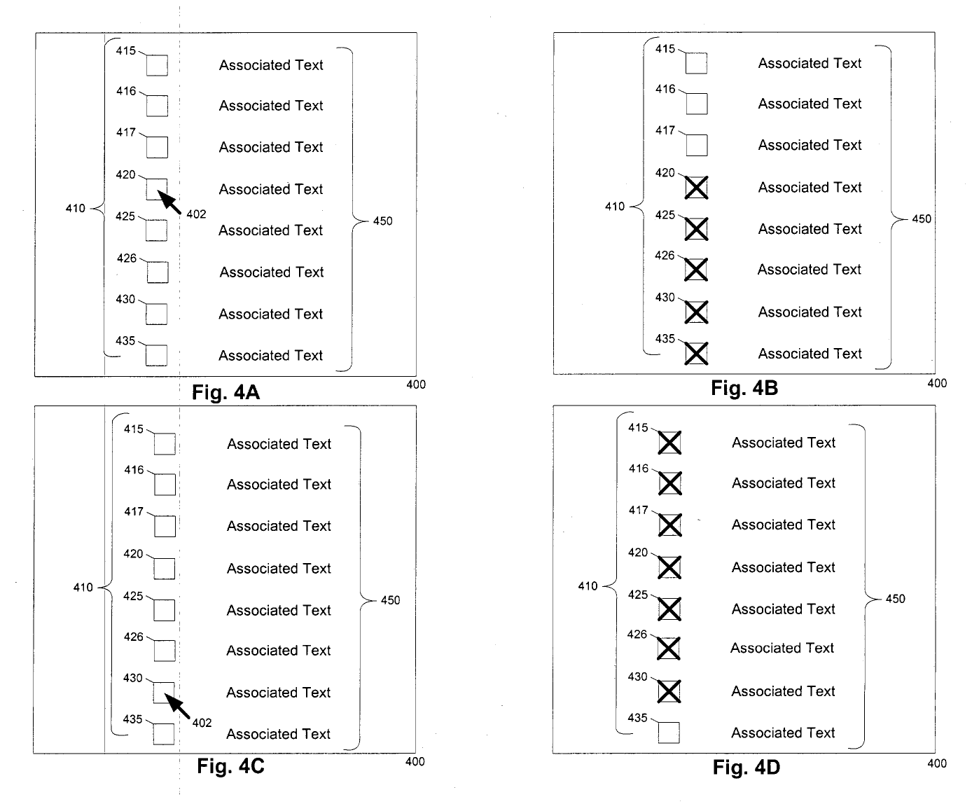

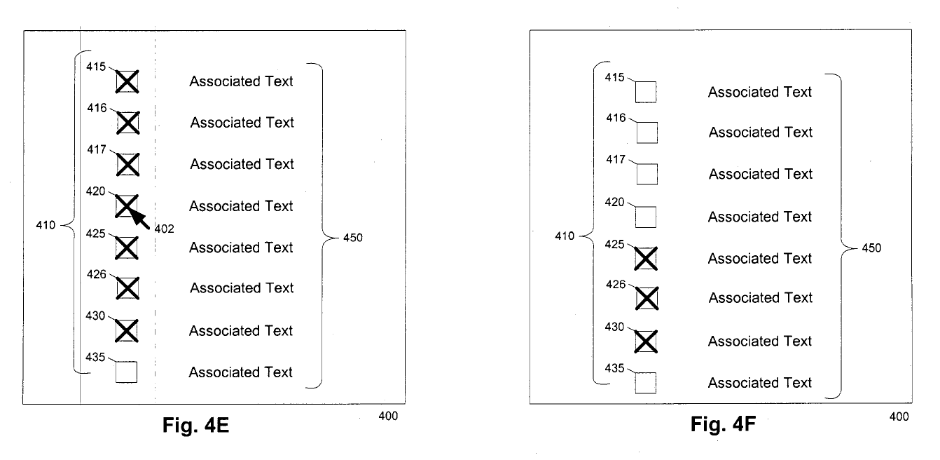

The exemplary embodiments of the present invention will now be discussed with reference to FIGS. 3 and 4.

In general, the present invention can be described as a novel system and method for quickly and efficiently performing an operation on all or a portion of a plurality of objects, while preserving the ability to perform operations on individual objects. For illustrative purposes, the present invention will be described using a logically-defined group of graphical user interface objects, these examples are for illustrative purposes only and, a person skilled in the art will construe them broadly.

The present invention illustrates a software application that presents graphical objects representing multiple choice selections, which selections have been physically and logically grouped by a programmer writing the software application. These groups may be further divided into subgroups, whereby one group is a member of another group. The graphical object used for the multiple choice selection items may be a checkbox, or it may be some other type of graphical object used to represent the function described herein as being associated with a checkbox. For ease of description, this object is referred to hereinafter as a checkbox.

One aspect of the present invention allows for quick and efficient selection or deselection of all or part of the members of the logically-defined group of graphical user interface objects, by performing an action (i.e. performing certain actions using a mouse or pressing the check box on a touch-sensitive screen, etc.) associated with a rule. As an example, a user may select multiple boxes by moving the cursor over one of the check boxes and double clicking on a mouse button. In this example, if the status of the group was “not selected” before the user performs the action on the check box, the status of each group member dictated by the rule will change to “selected” once the check box is clicked, or action is performed. The face of the checkbox for each group member will then be shown with a check mark (equivalently, an “x” or shaded) in the checkbox, to indicate this status. At that point, if the user wishes, he can deselect the entire group by clicking on the check box in the same manner, or he can deselect individual members of the group by clicking on their associated checkbox.

Note also that clicking on an individual group member does not normally change the group selection status: it changes only the selection status of that individual group member. Unless, however, the clicking of the individual group member is associated with a rule, then, the individual change results in the group members associated with that rule having a selection status which is the same of the individual selection status. In addition, an optional feature of the exemplary embodiment of the present invention changes the group selection status to the individual group member status according to a rule when the individual member is “selected”, to align it with the selection status of the members. As an example, suppose that the group selection status is “not selected”, but that a user individually selects each group member, so that the group members all have the individual status “selected” and all have a check mark in their checkbox. If the user now clicks on the individual group member of this group, he expects the check marks of the group members associated with that rule to be removed. In order for this expected behavior to occur, this optional feature of the exemplary embodiment includes logic to detect whether the group selection status is out of alignment with the selection status of the group members, and to corrects it when necessary.

FIGS. 3A and 3B illustrate the logical steps performed by a computer application embodying the present invention. It will be obvious to one skilled in the art how to incorporate the processes of FIGS. 3A and 3B into a larger process for handling general interactions with a graphical user interface.

The process of using the present invention begins at Step 300, where a computer displays a plurality of selectable objects according to FIG. 3A. Next, the computer receives a selection indicator from a user or another process at Step 310. The selection indicator will be associated with at least one of the plurality of selectable objects. Next, based on the selection indicator, the computer identifies a rule to be applied to the selectable objects at Step 320. Finally, the computer modifies the status of the selectable objects in accordance with the rule at Step 330.

FIG. 3B illustrates an exemplary embodiment of the present invention, wherein the process includes a loop-back feature for performing multiple actions. The process begins with the computer displaying a plurality of selectable objects at Step 300. Next, the computer receives a selection indicator from a user or process at Step 310. The selection indicator will be associated with at least one of the plurality of selectable objects. Next, based on the selection indicator, the computer identifies a rule to be applied to the selection group at Step 320. Next, the computer modifies the status of each of the selectable objects in accordance with the rule at Step 330. Finally, the computer returns, at Step 340, to Step 310 ready to receive an additional selection indicator. The return Step 340 can be performed multiple times.

The flexibility of the present invention allows for the mapping of multiple selection indicators to multiple rules. Thus, the speed and efficiency of applying certain operations to groups of selectable objects can be customized depending on the application. In addition, subgroups are often used and the present invention can be utilized in a manner that restricts operations within a subgroup or can transcend into subgroups. In any particular embodiment of the present invention, one or more selection indicators can be mapped to one or more rules using a one to one mapping, many to one mapping or one to many mapping.

The selection indicators, or actions performed by the use or an application program may include, but are not limited to, the following types of actions: double clicking a mouse or equivalent button while the mouse pointer is over a particular object, clicking a mouse or equivalent button while the shift key is being held down, clicking a mouse or equivalent button while the control key is held down, pressing and holding a mouse or equivalent button and dragging the pointer icon over several selectable objects, pressing and holding a mouse or equivalent button for a certain period of time, triple clicking a mouse or equivalent button, clicking a mouse or equivalent button while the alt key is being held down, etc.

When a selection indicator or action is performed, a rule is then applied. The rule generally involves determining the appropriate selectable objects and then performing an operation with the appropriate selectable objects. Determining the appropriate selectable objects can be performed in several manners. For instance, the appropriate selectable objects can include all of the selectable objects above the selectable object under the mouse pointer, all of the selectable objects below the selectable object under the mouse pointer, the selectable objects in a range either above, below or both from the selectable object under the mouse pointer, all selectable objects that are in the current state, or share some other commonality with the selectable object under the mouse pointer, all selectable objects adjacent to the selectable object under the mouse pointer, all selectable objects to the left or right of the selectable object under the mouse pointer, etc. It should be noted that the appropriate selectable objects could be inclusive or exclusive of the selectable object under the mouse pointer. In addition, in the embodiment where the selection indicator includes dragging the mouse pointer over several selectable items, the appropriate selectable objects are identified by the action.

Once the appropriate selectable items are determined, the rule includes an operation to be performed on the appropriate selectable objects. Some examples of operations include, but are not limited to the following operations: enable or select all selectable objects above or below the present mouse pointer position (either inclusively or exclusively of the selectable object underneath the mouse pointer), set all selectable objects above or below the present mouse pointer position to the state of the selectable object under the mouse pointer, toggling the state of each selectable object for bi-state selectable objects, cycle to the next state for each selectable object having more than two states, etc.

FIGS. 4A-F depict an exemplary embodiment of the present invention illustrating several of the aforementioned actions and rules. The association of the action/rule combination as well as the actions and rules themselves are only for illustrative purposes and one skilled in the art would construe them broadly and not limiting. In FIG. 4A, for example, a screen shot 400 depicts a plurality of selectable objects 410 and its associated text 450. The plurality of selectable objects with sub-groups of objects 410 are defined as individual checkboxes 415-435. A mouse pointer 402 is located over checkbox 420. Upon performing an action, such as double clicking a button on the mouse, a rule is invoked, for example the fill below rule could be invoked. The results of this operation are shown in FIG. 4B with checkboxes 420 through 435 selected.

FIG. 4C provides another example. In this example, the mouse pointer 402 is located over checkbox 430. Upon performing an action, such as depressing the shift key and clicking a mouse button, a rule is invoked (i.e. the fill above rule). The results of this operation are shown in FIG. 4D where checkboxes 430 through 415 are selected.

FIG. 4E provides yet another example. In this example, a mouse pointer 402 is located over checkbox 420 and checkboxes 415 through 430 have been previously selected. Upon performing an action such as depressing the Ctrl key and clicking mouse button, a toggle above rule is invoked. The results of this operation are illustrated in FIG. 4F where the checkboxes 420 through 415 are modified in accordance with the toggle above rule, while checkboxes 430, 426 and 425 are not modified from the previous action in FIG. 4D.

One skilled in the art will appreciate that the application of the present invention can take many forms and function and the examples provided herein are only used to illustrate a few of these possibilities. The scope of the present invention is not limited by these examples.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for controlling the state of objects displayed by a computer program, comprising the steps of:
displaying a plurality of selectable objects, each object having a status associated therewith;
receiving a selection indicator for a selection group consisting of at least one of said plurality of selectable objects;
identifying a rule to be applied to said selection group; and
modifying the state of each of said plurality of selectable objects in said selection group in accordance with said rule.

2. The method of claim 1, wherein said plurality of selectable objects are a plurality of checkboxes.

3. The method of claim 1, wherein said rule is selected from the group consisting of: fill up, fill down, fill left, fill right and fill all.

4. The method of claim 3, wherein said rule is fill down.

5. The method of claim 1, wherein said step of modifying the status of each of said plurality of selectable objects further comprises placing an “x” inside of each of said selectable objects.

6. A method for controlling the state of objects displayed by a computer program, comprising the steps of:
displaying a plurality of selectable objects, each object having a status associated therewith;
receiving a selection indicator for a selection group consisting of at least one of said plurality of selectable objects;
identifying a rule to be applied to said selection group;
modifying the status of each of said plurality of selectable objects in said selection group in accordance with said rule; and
returning to said receiving step to receive an additional selection indicator for a selection group consisting of at least one of said plurality of selectable objects.

7. The method of claim 6, wherein said plurality of selectable objects are a plurality of checkboxes.

8. The method of claim 6, wherein said rule is selected from the group consisting of: fill up, fill down, fill left, fill right and fill all.

9. The method of claim 8, wherein said rule is fill down.

10. The method of claim 6, wherein said step of modifying the status of each of said plurality of selectable objects further comprises placing an “x” inside of each of said selectable objects.

11. A method for applying operations on one or more of a plurality of displayed objects, the method comprising the steps of:
displaying a plurality of objects;
receiving a selection indicator;
identifying a group of the plurality of displayed objects based at least in part on the selection indicator; and
performing an operation on the group of the plurality of displayed objects based on the selection indicator.

12. The method of claim 11, wherein each of said plurality of displayed objects resides in one of two states and said operation comprises changing the state of the group of the plurality of displayed objects to a particular state.

13. The method of claim 11, wherein each of said plurality of displayed objects resides in one of two states and said operation comprises toggling the state of the each displayed object in the group of the plurality of displayed objects.

14. The method of claim 11, wherein each of said plurality of displayed objects resides in one of a plurality of states and said operation comprises changing the state of each displayed object in the group of the plurality of displayed objects to a particular state.

15. The method of claim 11, wherein each of said plurality of displayed objects resides in one of a plurality of states and said operation comprises cycling the state of each displayed object in the group of the plurality of displayed objects to a next state of the plurality of states.

16. The method of claim 11, wherein said operation comprises providing a visual indicator that the operation has been performed on the group of displayed objects.
